(19) United States
(12) Patent Application Publication
(10) Pub. No.: US 2009/0047976 A1
(43) Pub. Date: Feb. 19, 2009

(54) Radio positioning system

(75) Inventors: Akira Fujii, Kawasaki (JP); Hidenori Sekiguchi, Kawasaki (JP); Masafumi Asai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/216,150

(22) Filed: Jun. 30, 2008

(30) Foreign Application Priority Data
Aug. 14, 2007 (JP) 2007-211530

(51) Int. Cl. H04Q 7/20

(52) U.S. Cl. 455/456.1

(57) ABSTRACT

A radio positioning system includes a plurality of base stations, each receiving a radio wave from a mobile terminal, and including a first base station whose position coordinates are known and a second base station whose position coordinates are unknown. The system also includes a distance measuring unit that measures a distance between the first and the second base stations based on the exchanging the radio waves; a position-coordinate calculating unit that calculates position coordinates of the second base station based on the measured distances; a determination control unit that determines a time reference station out of the base stations, and controls the time reference station to transmit a time reference pulse; and a distance-measurement control unit that calculates, using the time difference, a time difference between reception times of the wave signal at the base stations, and calculates position coordinates of the mobile terminal based on the time difference.

### BACKGROUND OF THE INVENTION

1. Field of the Invention

The present invention relates to a radio positioning system that based on a radio wave received from a mobile terminal in a plurality of base stations, calculates a position coordinate of the mobile terminal.

2. Description of the Related Art

In recent years, a radio positioning system that calculates (determines) a position coordinate of a mobile terminal using a plurality of base stations has been devised. As one of methods of determining a position coordinate of a mobile terminal using the radio positioning system, there is a time difference of arrival (TDOA) method.

FIG. 16 is a block diagram of a configuration of a radio positioning system in the past. As shown in the figure, the radio positioning system includes a mobile terminal (a tag) 5, base stations 10 to 50, and a calculation server 60.

In the TDOA method, first, the mobile terminal 5, a position coordinate of which is unknown, transmits a pulse wave. Base stations, position coordinates of which are known, receive the transmitted pulse wave (hereinafter, “transmission pulse”). A plurality of (e.g., when a two-dimensional position is measured, at least three) base stations are arranged in a measurement range and reception times of the transmission pulse are measured in the respective base stations.

The calculation server 60 acquires the reception times measured in the respective base stations and a positioning calculation for the mobile terminal 5. Specifically, the calculation server 60 calculates a time difference (a propagation time difference) between two base stations from the reception times of the transmission pulse in the respective base stations and obtains a hyperbola from the time difference. The calculation server 60 calculates a position corresponding to an intersection of a plurality of hyperbolas as a position coordinate of the mobile terminal 5.

To determine a position coordinate of the mobile terminal 5 according to the TDOA method described above, positions of the respective base stations 10 to 50 need to be accurately calculated in advance. To calculate a propagation time difference, clocks of the base stations need to be matched at accuracy equal to or higher than time accuracy necessary for the positioning calculation for the mobile terminal 5.

To match the clocks of the respective base stations, in the radio positioning system in the past, a specific base station 10 is set as a time reference station, the time reference station transmits a time reference pulse from the time reference station, and the respective base stations 20 to 50 receive the time reference pulse to set the clocks. As in initial setting for positioning, to perform the clock setting, position coordinates of all the base stations 10 to 50 need to be accurately known.

As a method of transmitting the time reference pulse from the time reference station, for example, the time reference pulse is periodically transmitted or, as disclosed in Japanese Patent Application Laid-open No. 2005-140617, when a positioning pulse from a mobile terminal is received, the time reference pulse is transmitted (i.e., the time reference pulse is irregularly transmitted).

However, in the technology in the past described above, to accurately determine a position coordinate of the mobile terminal, it is necessary to accurately manage position coordinates of all the base stations included in the radio positioning system. It is also necessary to set a position of the time reference station such that the time reference pulse reaches all the base stations. Therefore, the operator is forced to perform complicated work and cannot smoothly set the radio positioning system because of a limitation on the time reference station.

Moreover, even when positioning is started after determining the time reference station, all the base stations may not be able to receive the time reference pulse from the time reference station because of a change in an environment in which the radio positioning system is used (e.g., when an obstacle is set anew). FIG. 17 is a diagram for explaining the problem in the past.

As shown in FIG. 17, the time reference pulse does not reach the base station 40 because of the obstacle, the clock setting for the base station 40 cannot be performed, and an error during calculation of a time difference increases. Therefore, the reception time of the base station 40 cannot be used when positioning of the mobile terminal is performed. As a result, the base stations are useless and positioning accuracy is deteriorated.

It is extremely important to reduce a burden on the operator who sets the radio positioning system and accurately determine a position coordinate of the mobile terminal even when the environment changes.

### SUMMARY

It is an object of the present invention to at least partially solve the problems in the conventional technology.

According to an aspect of the present invention, a radio positioning system includes a plurality of base stations, each receiving a radio wave from a mobile terminal, and including a first base station whose position coordinates are known and a second base station whose position coordinates are unknown. The system also includes a distance measuring unit that measures a distance between the first and the second base stations based on a result of exchanging radio waves between the first and the second base stations; a position-coordinate calculating unit that calculates position coordinates of the second base station based on the measured distance; a determination control unit that determines a time reference station out of the base stations, and controls the time reference station to transmit a time reference pulse; and a distance-measurement control unit that calculates, using the time difference, a time difference between reception times at which the base stations receive the wave signal from the mobile terminal, and calculates position coordinates of the mobile terminal based on the time difference.

According to another aspect of the present invention, a radio positioning server apparatus is used in a system including a plurality of base stations each receiving a radio wave from a mobile terminal, the base stations including a first base station whose position coordinates are known and a second base station whose position coordinates are unknown. The apparatus includes a distance measuring unit that measures a distance between the first and the second base stations based on a result of exchanging radio waves between the first and the second base stations; a position-coordinate calculating unit that calculates position coordinates of the second base station based on the measured distance; a determination control unit that determines a time reference station out of the base stations, and controls the time reference station to transmit a time reference pulse; and a distance-measurement control unit that calculates, using the time difference, a time difference between reception times at which the base stations receive the wave signal from the mobile terminal, and calculates position coordinates of the mobile terminal based on the time difference.

According to still another aspect of the present invention, a method is for radio positioning a mobile terminal in a system including a plurality of base stations, the base stations including a first base station whose position coordinates are known and a second base station whose position coordinates are unknown. The method includes exchanging radio waves between the first and the second base stations; measuring a distance between the first and the second base stations based on a result of exchanging radio waves between the first and the second base stations; calculating position coordinates of the second base station based on the measured distance; determining a time reference station out of the base stations; controlling the time reference station to transmit a time reference pulse; calculating, using the time difference, a time difference between reception times at which the base stations receive the wave signal from the mobile terminal; and calculating position coordinates of the mobile terminal based on the time difference.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an overview and characteristics of a radio positioning system according to an embodiment of the present invention;

FIG. 2 is a diagram of a configuration of the radio positioning system according to the embodiment;

FIG. 3 is a functional block diagram of the structure of a mobile terminal;

FIG. 4 is a functional block diagram of the structure of a base station;

FIG. 5 is a functional block diagram of the structure of a calculation server;

FIG. 6 is a diagram of an example of the data structure of a management table;

FIG. 7 is a diagram of an example the data structure of a candidate list table;

FIG. 8 is a diagram for explaining a change in a reception state of a time reference pulse;

FIG. 9 is another diagram for explaining the change in the reception state of the time reference pulse;

FIG. 10 is a diagram of timings of a time reference pulse transmitted from a time reference station and a time reference pulse transmitted from a candidate station;

FIG. 11 is a flowchart of processing by the calculation server for calculating position coordinates of base station;

FIG. 12 is a flowchart of processing by the calculation server for selecting a time reference station;

FIG. 13 is a flowchart of processing by the calculation server for switching the time reference station;

FIG. 14 is a flowchart of a processing procedure of time reference station switching processing;

FIG. 15 is a diagram of a hardware configuration of a computer of the calculation server shown in FIG. 5;

FIG. 16 is a block diagram of a configuration of a radio positioning system in the past; and

FIG. 17 is a diagram for explaining problems in the past.

### DETAILED DESCRIPTION OF THE PREFERRED EMBODIMENTS

Exemplary embodiments of the present invention are explained in detail below with reference to the accompanying drawings.

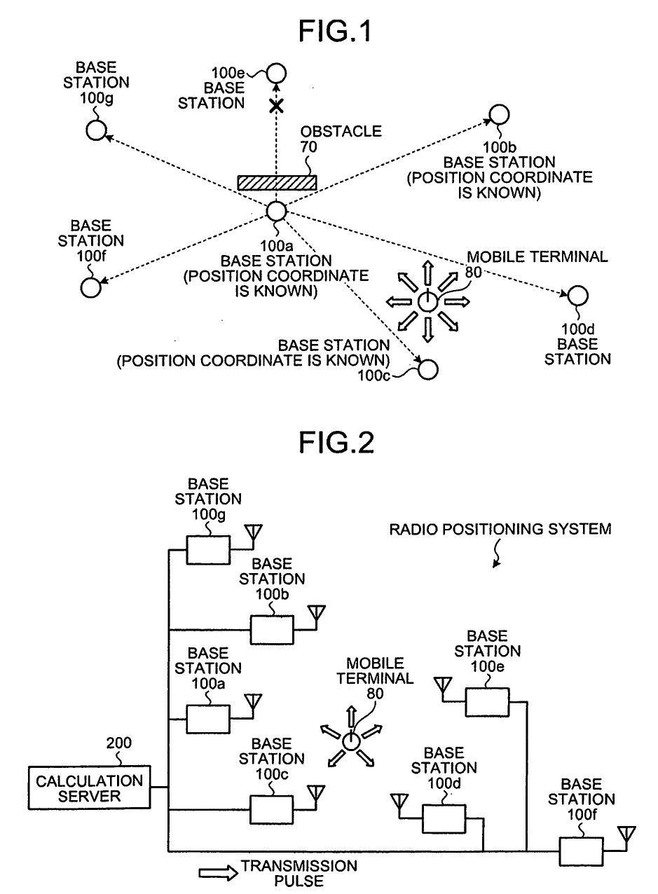

FIG. 1 is a diagram for explaining an overview and characteristics of a radio positioning system according to an embodiment of the present invention. During initial setting, base stations, position coordinates of which are unknown, (e.g., base stations 100d to 100g) are present. Even in such a case, the radio positioning system according to this embodiment performs two-way communication between base stations, position coordinates of which are known, (e.g., base stations 100a to 100c) and the base stations, position coordinates of which are unknown. The radio positioning system calculates distances among the respective base stations and calculates position coordinates of the base stations 100d to 100g (e.g., calculates position coordinates using the triangulation).

The radio positioning system receives a transmission pulse transmitted from a mobile terminal 80 in the base stations 100a to 100g, position coordinates of which are known, and calculates position coordinates of the mobile terminal 80 from a difference among reception times. The radio positioning system according to the first embodiment monitors reception states of a time reference pulse in the respective base stations (a pulse for matching timers of the base stations 100a to 100g). The radio positioning system switches, according to the reception states of the time reference pulse, a base station that transmits the time reference pulse (hereinafter, “time reference station”)

For example, under a situation in which a base station 100a is operated as a time reference station during initial setting of the radio positioning system, a time reference pulse from the base station 100a is not transmitted to the base station 100e because of the influence of an obstacle 70. In such a case, the radio positioning system dynamically switches the base station as the time reference station to another base station. For example, the time reference pulse from the base station 100b can be transmitted to the respective base stations 100a, and 100c to 100g (the number of base stations that can receive the time reference pulse is larger when the time reference pulse is transmitted from the base station 100b than when the time reference pulse is transmitted from the base station 100a). The radio positioning system switches the time reference base station from the base station 100a to the base station 100b.

In this way, during initial setting, even when base stations, position coordinates of which are unknown, are present, the radio positioning system according to this embodiment performs two-way communication between base stations, position coordinates of which are known, and the base stations, position coordinates of which are unknown, to calculate distances among the base stations and calculates position coordinates of the base stations. Therefore, an operator does not need to set in advance position coordinates of all the base stations of the radio positioning system (position coordinates of a necessary minimum number of base stations only have to be calculated). Consequently, it is possible to reduce a burden on the operator, efficiently carry out setting of the radio positioning system, and improve positioning accuracy.

The radio positioning system according to this embodiment monitors reception states of the time reference pulse in the respective base stations and switches the time reference station according to the reception states. Therefore, it is possible to effectively use the respective base stations and improve positioning accuracy.

FIG. 2 is a diagram of a configuration of the radio positioning system according to this embodiment. As shown in the figure, the radio positioning system includes the mobile terminal 80, the base stations 100a to 100g, and a calculation server 200. As an example, only the base stations 100a to 100g are shown. However, the radio positioning system includes other base stations as well.

The mobile terminal 80 is an apparatus that transmits a transmission pulse to the respective base stations 100a to 100g. The base stations 100a to 100g are apparatuses that are connected to the calculation server 200, receive the transmission pulse transmitted from the mobile terminal 80, and output various data related to calculation of a position coordinate of the mobile terminal 80 to the calculation server 200. The calculation server 200 is an apparatus that calculates a position coordinate of the mobile terminal 80 based on the various data output from the base stations 100a to 100g.

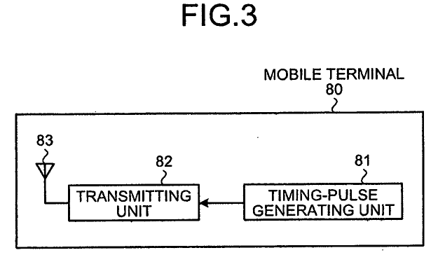

FIG. 3 is a functional block diagram of the structure of the mobile terminal 80.

As shown in FIG. 3, the mobile terminal 80 includes a timing-pulse generating unit 81, a transmitting unit 82, and an antenna 83. The timing-pulse generating unit 81 is a means for generating a timing pulse for forming a pulse train of the transmission pulse with pulse position modulation (PPM).

The transmitting unit 82 is a means for acquiring the timing pulse from the timing-pulse generating unit 81, generating a transmission pulse having a pulse train corresponding to timing of the acquired timing pulse, and outputting the transmission pulse (e.g., an impulse radio wave in an ultra wide band (UWB)) from the antenna 83.

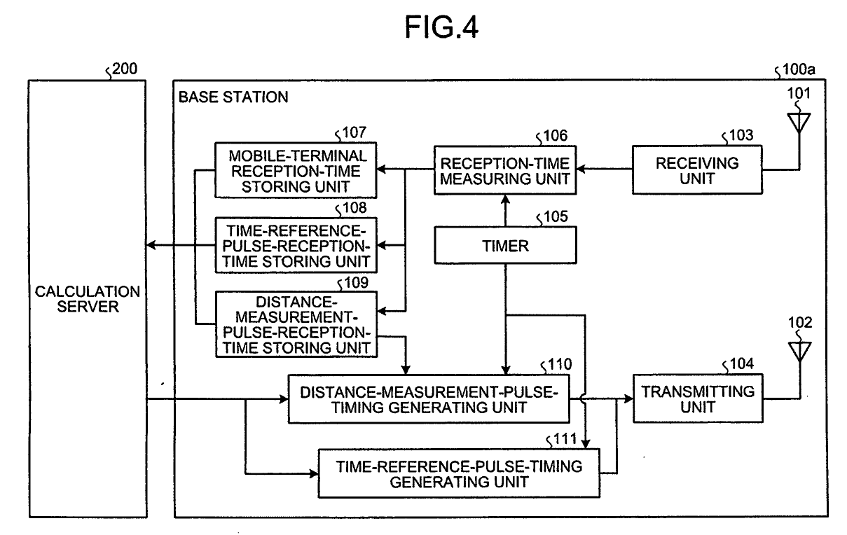

FIG. 4 is a functional block diagram of the structure of the base station 100a. Only the base station 100a is shown in the figure because all the base stations 100a to 100g have the same structure.

As shown in FIG. 4, the base station 100a includes antennas 101 and 102, a receiving unit 103, a transmitting unit 104, a timer 105, a reception-time measuring unit 106, a mobile-terminal reception-time storing unit 107, a time-reference-pulse-reception-time storing unit 108, a distance-measurement-pulse-reception-time storing unit 109, a distance-measurement-pulse-timing generating unit 110, and a time-reference-pulse-timing generating unit 111.

The receiving unit 103 is a means for receiving a transmission pulse transmitted from the mobile terminal 80, a time reference pulse, a distance measurement pulse (a pulse used for measuring a distance between base stations), and the like via the antenna 101. The receiving unit 103 can receive an impulse radio wave in the UWB. The receiving unit 103 digitizes the received impulse radio wave and outputs the impulse radio wave to the reception-time measuring unit 106.

The transmitting unit 104 is a means for transmitting the time reference pulse, the distance measurement pulse, and the like via the antenna 102. The transmitting unit 104 can transmit the impulse radio wave in the UWB.

The timer 105 is a means for outputting time information to the reception-time measuring unit 106, the distance-measurement-pulse-timing generating unit 110, and the time-reference-pulse-timing generating unit 111. Reception time generated by the timer 105 is corrected in the calculation server 200 during positioning calculation in the calculation server 200 described later.

The reception-time measuring unit 106 is a means for acquiring various pulse signals (a transmission pulse train, a time reference pulse train, and a distance measurement pulse train) and measuring time when the pulse signals are acquired. The reception-time measuring unit 106 temporally correlates a transmission pulse train formed of a plurality of pulses (various pulse signals received by the receiving unit 103) and a pulse train, a pattern of which is known, to synchronize timing of the pulse trains and sets time when a predetermined timing pulse in the transmission pulse train is received as reception time.

The reception-time measuring unit 106 stores various pulse patterns in advance. The reception-time measuring unit 106 compares such pulse patterns and pulse patterns of the various pulse signals acquired from the receiving unit 103 to determine types (the transmission pulse, the time reference pulse, and the distance measurement pulse) of the respective pulse signals. The reception-time measuring unit 106 also includes a function for demodulating data included in the various pulse trains (demodulation of the PPM modulation). For example, the distance measurement pulse train includes a base station identification number of a transmission source of the distance measurement pulse train.

The reception-time measuring unit 106 outputs reception time of the transmission pulse and data included in the pulse train to the mobile-terminal reception-time storing unit 107, outputs reception time of the time reference pulse and data included in the pulse train to the time-reference-pulse-reception-time storing unit 108, and outputs reception time of the distance measurement pulse and data included in the pulse train to the distance-measurement-pulse-reception-time storing unit 109.

The mobile-terminal reception-time storing unit 107 is a means for acquiring reception time of the transmission pulse and data included in the pulse train from the reception-time measuring unit 106 and storing the acquired reception-time of the transmission pulse and the acquired data included in the pulse train. The mobile-terminal reception-time storing unit 107 outputs the reception time of the transmission pulse and the data included in the pulse train to the calculation server 200.

The time-reference-pulse-reception-time storing unit 108 is a means for acquiring reception time of the time reference pulse and data included in the pulse train from the reception-time measuring unit 106 and storing the acquired reception time of the time reference pulse and the acquired data include in the pulse train. The time-reference-pulse-reception-time storing unit 108 outputs the reception time of the time reference pulse and the data included in the pulse train to the calculation server 200.

The distance-measurement-pulse-reception-time storing unit 109 is a means for acquiring reception time of the distance measurement pulse and data included in the pulse train from the reception-time measuring unit 106 and storing the acquired reception time of the distance measurement pulse and the acquired data included in the pulse train. The distance-measurement-pulse-reception-time storing unit 109 outputs the reception time of the distance measurement pulse and the data included in the pulse train to the calculation server 200.

The distance-measurement-pulse-timing generating unit 110 is a means for performing transmission control for the distance measurement pulse based on setting from the calculation server 200. When the distance-measurement-pulse-timing generating unit 110 receives the distance measurement pulse transmitted to an own station (in the example shown in FIG. 4, the base station 100a) from another base station, the distance-measurement-pulse-timing generating unit 110 returns the distance measurement pulse to the base station at a transmission source. When the distance-measurement-pulse-timing generating units 110 of the respective base stations execute two-way communication of the distance measurement pulse, distances among the base stations can be measured.

The distance-measurement-pulse-timing generating unit 110 determines a base station at a transmission source from the data included in the pulse train of the distance-measurement-pulse-reception-time storing unit 109.

The time-reference-pulse-timing generating unit 111 is a means for performing transmission control for the time reference pulse based on setting from the calculation server 200. The respective base stations include the time-reference-pulse-timing generating units 111 and can transmit the time reference pulse according to the setting from the calculation server 200. Therefore, the respective base stations can realize a function of the time reference station.

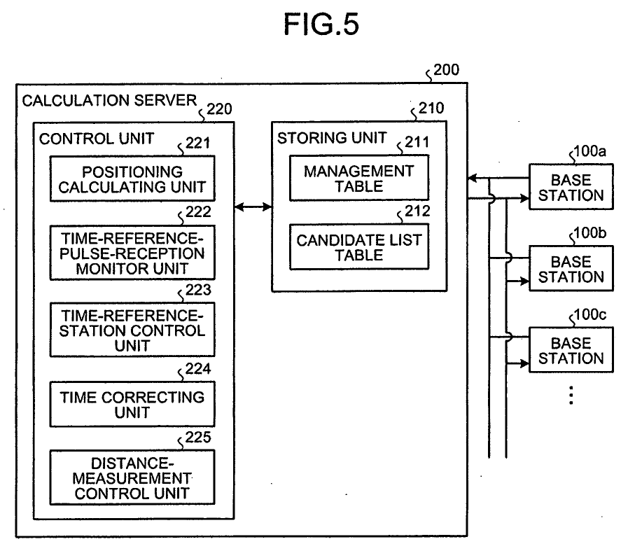

FIG. 5 is a functional block diagram of the structure of the calculation server 200. As shown in the figure, the calculation server 200 includes a storing unit 210 and a control unit 220.

The storing unit 210 is a storing means for storing data and programs necessary for various kinds of processing by the control unit 220. As tables particularly closely related to the present invention, as shown in FIG. 5, the storing unit 210 includes a management table 211 and a candidate list table 212.

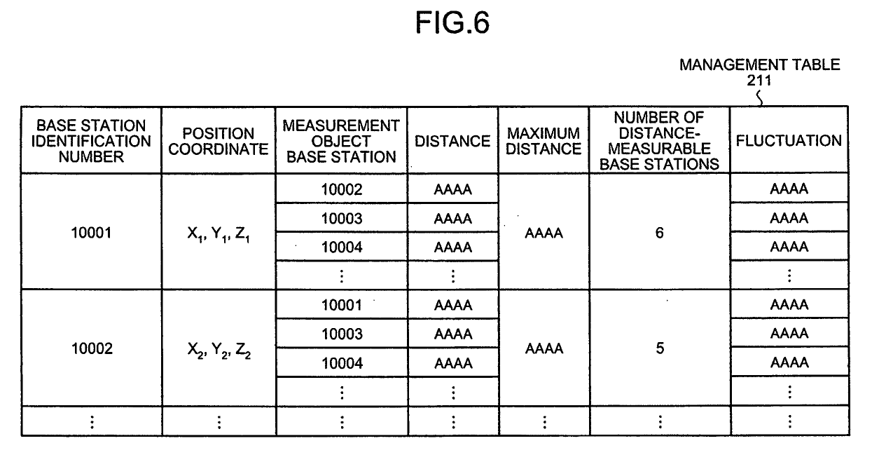

The management table 211 is a table that stores data such as position coordinates of the respective base stations 100a to 100g and distances among the respective base stations. FIG. 6 is a diagram of an example of the data structure of the management table 211. As shown in the figure, the management table 211 includes a base station identification number, a position coordinate, a measurement object base station, a distance, a maximum distance, the number of distance-measurable base stations, and fluctuation.

In FIG. 6, the base station identification number is information for identifying the respective base stations 100a to 100g. In this embodiment, a base station identification number “10001” corresponds to the base station 100a, a base station identification number “10002”, corresponds to the base station 100b, and a base station identification number “10007” corresponds to the base station 100g.

The position coordinate is information concerning a position coordinate of a base station. The measurement object base station is information concerning a base station as an object of measurement of a distance. The distance is information concerning a distance from a base station to the measurement object base station. For example, in a first section of a distance field of the management table 21 shown in FIG. 6, information concerning a distance from the base station identification number “10001” to the measurement object base station “1002” is stored. When a distance from a base station to the measurement object base station is measured a plurality of numbers of times, an average of measured distances is stored in the distance field.

The maximum distance indicates information concerning a maximum distance among distances from the base station (e.g., the base station 100a) to the respective measurement object base stations (the base stations 100b to 100g). The number of distance-measurable base stations indicates the number of base stations, distances to which from the base station 100a can be measured. For example, the number of distance-measurable base stations corresponding to the base station 100a indicates the number of base stations, distances to which from the base station 100a can be measured. For example, when all distances from the base station 100a to the respective base stations 100b to 100g can be measured, the number of distance-measurable base stations corresponding to the base station 100a is “6”.

The fluctuation indicates fluctuation (e.g., standard deviation) that occurs when distances among the respective base stations are measured a plurality of number of times. For example, when a distance from the base station 100a to the base station 100b is measured a plurality of number of times, fluctuation is calculated by a publicly-known method based on information concerning the measured distances.

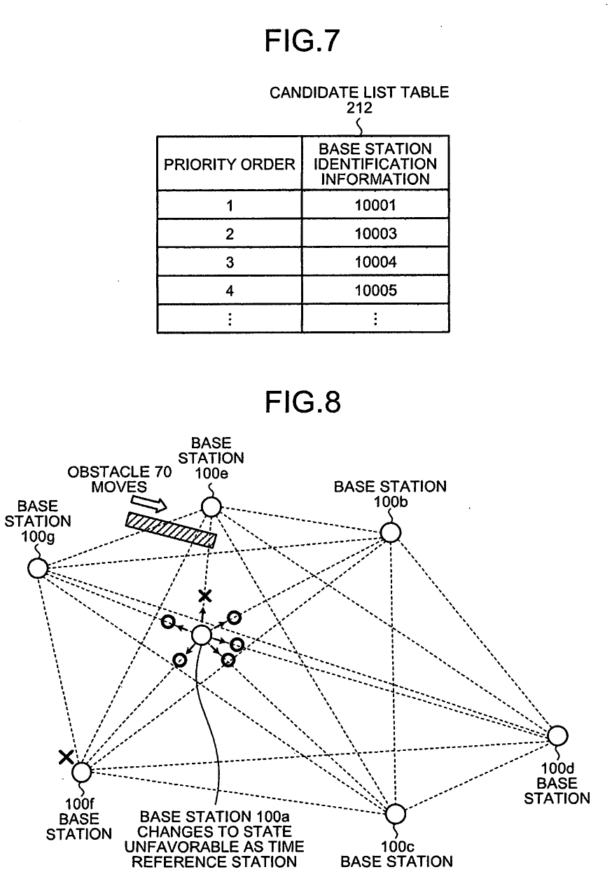

The candidate list table 212 is a table that stores priority order of base stations for selecting, out of the base stations 100a to 100g, a base station that transmits the time reference pulse. FIG. 7 is a diagram of an example of the data structure of the candidate list table 212. As shown in the figure, the candidate list table 212 stores the priority order and base station identification information in association with each other.

Referring back to FIG. 5, the control unit 220 has an internal memory for storing programs and control data that define various processing procedures. The control unit 220 is a means for executing various kinds of processing according to the programs and the control data. As units particularly closely related to the present invention, as shown in FIG. 5, the control unit 220 includes a positioning calculating unit 221, a time-reference-pulse-reception monitor unit 222, a time-reference-station control unit 223, a time correcting unit 224, and a distance-measurement control unit 225.

The positioning calculating unit 221 is a means for calculating a position coordinate of the mobile terminal 80 according to the publicly-known TDOA method. In other words, the positioning calculating unit 221 acquires reception times of the transmission pulse from the respective base stations 100a to 100g and calculates a position coordinate of the mobile terminal 80 based on time differences among the reception times of the respective base stations and the position coordinates of the respective base stations stored in the management table 211.

The time-reference-pulse-reception monitor unit 222 is a means for monitoring presence or absence of reception of the time reference pulse in the respective base stations 100a to 100g and, when there are a predetermined number or more of base stations that do not receive the time reference pulse continuously for a predetermined time, generates a trigger for performing reset of the time reference station (a reset trigger).

Specifically, the time-reference-pulse-reception monitor unit 222 acquires reception times of the time reference pulse from the time-reference-pulse-reception-time storing units 108 of the respective base stations 100a to 100g. When there are a predetermined number or more of base stations in which such reception times are not updated continuously for a predetermined time, the time-reference-pulse-reception monitor unit 222 generates the reset trigger.

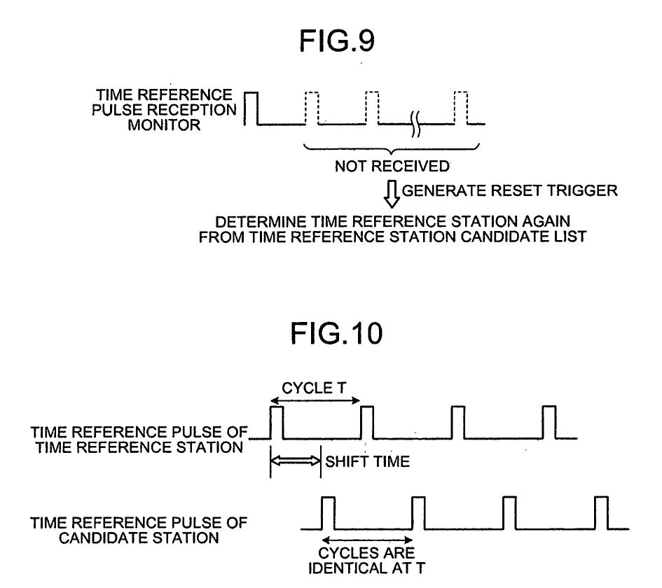

FIGS. 8 and 9 are diagrams for explaining a change in a reception state of the time reference pulse. As shown in FIG. 8, at a stage of initial setting, when the obstacle 70 moves under a situation in which the base station 100a is set in the time reference station, a transmission path from the base station 100a to the base station 100g is blocked. As shown in FIG. 9, the base station 100e cannot receive the time reference pulse. When there are a predetermined number or more of base stations in such a state, the time-reference-pulse-reception monitor unit 222 generates the reset trigger.

The time-reference-pulse-reception monitor unit 222 also monitors a reception state of the time reference pulse transmitted from a candidate station (described later), judges whether such a candidate station is suitable for a time reference station, and outputs a result of the judgment to the time-reference-station control unit 223. For example, when there are a predetermined number or more of base stations that receive the time reference pulse, which is transmitted from the candidate station, continuously for a predetermined time, the time-reference-pulse-reception monitor unit 222 judges that the candidate station is suitable for the next time reference station.

The time-reference-station control unit 223 is a means for selecting, when the reset trigger is generated by the time-reference-pulse-reception monitor unit 222, a time reference station from the base stations 100a to 100g and controlling transmission of the time reference pulse by the selected time reference station.

Specifically, when the reset trigger is generated, the time-reference-station control unit 223 sets, as a new time reference station, a base station having the highest priority next to the base station set as the present time reference station referring to the candidate list table 212 (see FIG. 7). For example, in FIG. 7, the reset trigger is generated in a state in which the base station 100a (the base station identification number “10001”) having the priority “1” is set as the present time reference station. The time-reference-station control unit 223 sets the base station 100c (the base station identification number “10003”) having the priority “2” as a new time reference station.

When the new time reference station is selected, the time-reference-station control unit 223 selects a base station having the highest priority next to the selected time reference station as a candidate station. The time-reference-station control unit 223 causes the candidate station to transmit the time reference pulse at a timing different from a timing of the time reference pulse transmitted from the time reference station. For example, in FIG. 7, when the base station 100c (the base station identification number “10003”) is selected as a time reference station anew, the time-reference-station control unit 223 selects the base station 100d (the base station identification number “10004”) having the next highest priority as a candidate station.

FIG. 10 is a diagram of timing of the time reference pulse transmitted from the time reference station and the time reference pulse transmitted from the candidate station. As shown in the figure, a pulse train of the time reference pulse output from the time reference station and a pulse train of the timer reference pulse output from the candidate station shift from each other by a predetermined time. However, cycles of both the time reference pulses are identical at T.

In this way, the time-reference-station control unit 223 causes the candidate station to transmit the time reference pulse. This makes it possible to judge in advance whether the candidate station is suitable for the time reference station and efficiently carry out switching of the time reference station. In other words, the time-reference-station control unit 223 causes the candidate station to transmit the time reference pulse in advance and, when the time-reference-pulse-reception monitor unit 222 judges that the candidate station is not suitable for the time reference station, skips such a candidate station and switches a base station having the next highest priority as a candidate of the time reference station. Therefore, it is possible to efficiently execute selection of the time reference station.

Referring back to FIG. 5, the time correcting unit 224 is a means for controlling the respective base stations 100a to 100g and correcting, for each of the base stations, a reception time obtained by a timer of the base station based on the time reference pulse received by the base station. As a method with which the time correcting unit 224 corrects reception time based on the time reference pulse, a well-known method only has to be used.

The distance-measurement control unit 225 is a means for causing the respective base stations 100a to 100g to transmit a distance measurement pulse, calculating distances among the respective base stations, position coordinates of the base stations, and the like, and managing the management table 211 and the candidate list table 212.

A method with which the distance-measurement control unit 225 calculates distances among the respective base stations is explained. For convenience of explanation, a method of calculating a distance between the base station 100a and the base station 100b is explained as an example. A method of calculating distances among the other base stations is the same as the method of calculating a distance between the base station 100a and the base station 100b. Therefore, explanation of the method is omitted.

The distance-measurement control unit 225 acquires, from the base station 100a and the base station 100b, time T₁, when the base station 100a transmits the distance measurement pulse to the base station 100b, time T₂ when the base station 100b receives the distance measurement pulse from the base station 100a, time T₃ when the base station 100b transmits a response pulse for the distance measurement pulse to the base station 100a, and time T₄ when the base station 100a receives the response pulse from the base station 100b.

The distance-measurement control unit 225 calculates a distance L between the base stations using the following equation:

$$L = \frac{( {T}_{4} - {T}_{1} ) - ( {T}_{3} - {T}_{2} )}{2} \times C \qquad ( 1 )$$

where “C” indicates—“speed of sound”.

The distance-measurement control unit 225 calculates distances between the base stations a plurality of number of times using Equation (1) and registers an average of the calculated distances in the management table 211 as a distance between the base stations. The distance-measurement control unit 225 calculates, based on the calculated distances, fluctuation in the distance between the base stations (e.g., a standard deviation) and registers the calculated fluctuation in the management table 211.

The distance-measurement control unit 225 calculates, based on the distance between the base stations, a maximum distance between the base stations and the number of distance-measurable base stations. The distance-measurement control unit 225 registers the calculated values in a maximum distance field and a number of distance-measurable base stations field of the management table 211.

A method with which the distance-measurement control unit 225 calculates position coordinates of base stations, position coordinates of which are unknown, is explained. It is assumed that all the base stations are within an identical plane and position coordinates can be calculated two-dimensionally. As a method with which the distance-measurement control unit 225 calculates a distance between base stations, there are a method of using position coordinates of two base stations and a direction of one base station, a method of using position coordinates of three base stations, and the like.

A method of using position coordinates of three base stations is explained. In this method, position coordinates of at least three base stations among base stations configuring the radio positioning system need to be known. Position coordinates of base stations, distances to which from three base stations in the known positions can be measured, can be calculated by the triangulation.

The distance-measurement control unit 225 detects the three base stations in the know position coordinates and all base stations, distances to which from the three base stations can be measured, (base stations, position coordinates of which are unknown) referring to the management table 211 and sequentially calculates position coordinates of the respective base stations using the triangulation. In this example, position coordinates of the respective base stations are calculated by using the triangulation. However, the present invention is not limited to this. Position coordinates of the respective base stations can be calculated by using the least square method.

Processing by the distance-measurement control unit 225 for generating the candidate list table 212 is explained. The distance-measurement control unit 225 determines priority order of the time reference station based on the number of distance-measurable base stations, the maximum distance, and the fluctuation referring to the management table 211.

The distance-measurement control unit 225 can generates the candidate list table 212 in order from a base station having a largest number of distance-measurable base stations to a base station having a smallest number of distance-measurable base stations. The distance-measurement control unit 225 can also generate the candidate list table 212 in order from a base station having a smallest maximum distance to a base station having a largest maximum distance. Moreover, the distance-measurement control unit 225 can generate the candidate list table 212 in order from a base station having smallest fluctuation to a base station having largest fluctuation.

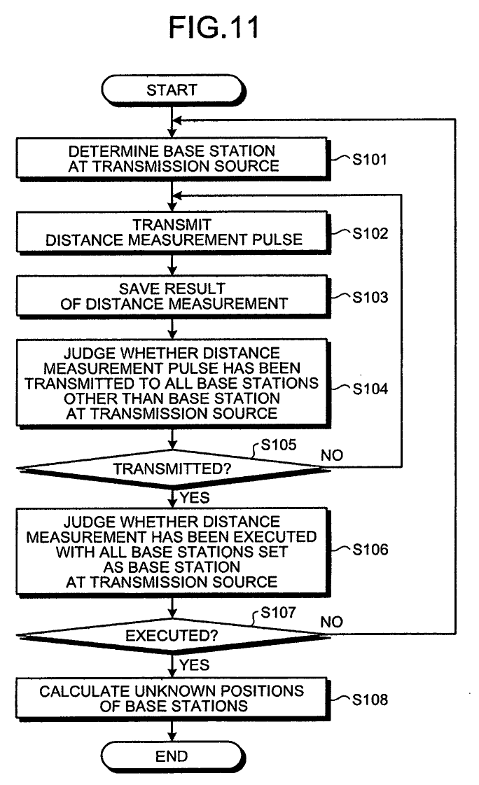

FIG. 11 is a flowchart of processing by the calculation server 200 for calculating position coordinates of base stations. As shown in the figure, in the calculation server 200, the distance-measurement control unit 225 determines a base station at a transmission source (a base station that transmits the distance measurement pulse) referring to the management table 211 (step S101) and causes the base station to transmit the distance measurement pulse (step S102).

The distance-measurement control unit 225 measures distances among the respective base stations and saves a result of the measurement in the management table 211 (step S103). The distance-measurement control unit 225 judges whether the distance measurement pulse has been transmitted to all the base stations other than the base station at the transmission source (step S104).

When the distance measurement pulse has not been transmitted to all the base stations (“No” at step S105), the distance-measurement control unit 225 shifts to step S102. On the other hand, when the distance measurement pulse has been transmitted to all the base stations (“Yes” at step S105), the distance-measurement control unit 225 judges whether distance measurement has been executed with all the base stations set as the base station at the transmission source (step S106).

When the distance measurement has not been executed with all the base stations set as the base station at the transmission source (“No” at step S107), the distance-measurement control unit 225 shifts to step S101. When the distance measurement has been executed with all the base stations set as the base station at the transmission source (“Yes” at step S107), the distance-measurement control unit 225 calculates unknown position coordinates of the base stations using the distances among the base stations and position coordinates of the base stations (step S108).

In this way, the distance-measurement control unit 225 causes the base stations to transmit the distance measurement pulse to one another to calculate distances among the base stations and calculates unknown position coordinates of the base stations using the calculated distances among the base stations and position coordinates of the base stations (base stations, position coordinates of which are known). Therefore, the operator does not need to specify position coordinates of all the base stations. It is possible to reduce a burden on the operator.

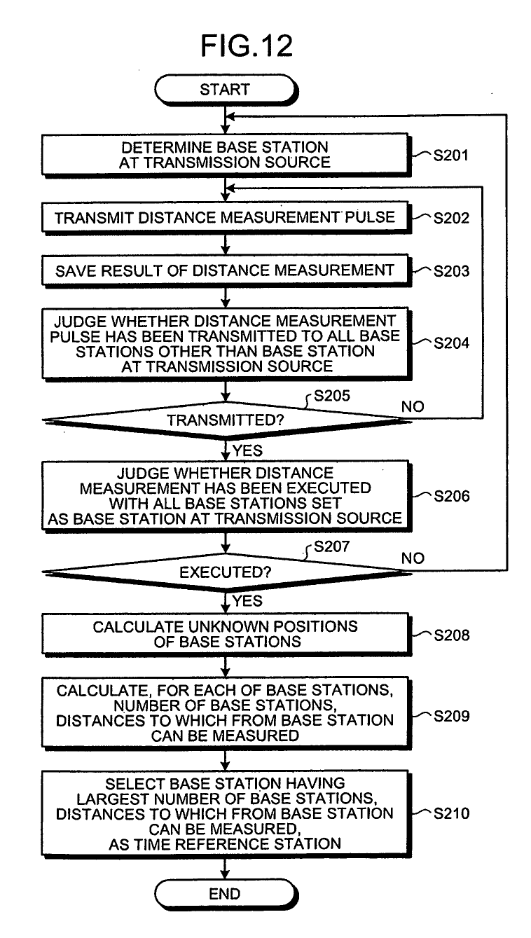

FIG. 12 is a flowchart of processing by the calculation server 200 for selecting a time base station. As shown in the figure, in the calculation server 200, the distance-measurement control unit 225 determines a base station at a transmission source (a base station that transmits the distance measurement pulse) referring to the management table 211 (step S201) and causes the base station to transmit the distance measurement pulse (step S202).

The distance-measurement control unit 225 measures distances among the respective base stations and saves a result of the measurement in the management table 211 (step S203). The distance-measurement control unit 225 judges whether the distance measurement pulse has been transmitted to all the base stations other than the base station at the transmission source (step S204).

When the distance measurement pulse has not been transmitted to all the base stations (“No” at step S205), the distance-measurement control unit 225 shifts to step S202. On the other hand, when the distance measurement pulse has been transmitted to all the base stations (“Yes” at step S205), the distance-measurement control unit 225 judges whether distance measurement has been executed with all the base stations set as the base station at the transmission source (step S206).

When the distance measurement has not been executed with all the base stations set as the base station at the transmission source (“No” at step S207), the distance-measurement control unit 225 shifts to step S201. When the distance measurement has been executed with all the base stations set as the base station at the transmission source (“Yes” at step S207), the distance-measurement control unit 225 calculates unknown position coordinates of the base stations using the distances among the base stations and position coordinates of the base stations (step S208).

The distance-measurement control unit 225 calculates, for each of the base stations, the number of base stations, distances to which from the base station can be measured, (the number of distance-measurable base stations) referring to the management table 211 (step S209) . The distance-measurement control unit 225 selects a base station having a largest number of base stations, distances to which from the base station can be measured, as a time reference station (step S210).

At step S210, as an example, the base station having the largest number of distance-measurable base stations is selected as the time reference station. However, the present invention is not limited to this. A base station having a smallest maximum distance can be selected as the time reference station or a base station having smallest fluctuation can be selected as the time reference station.

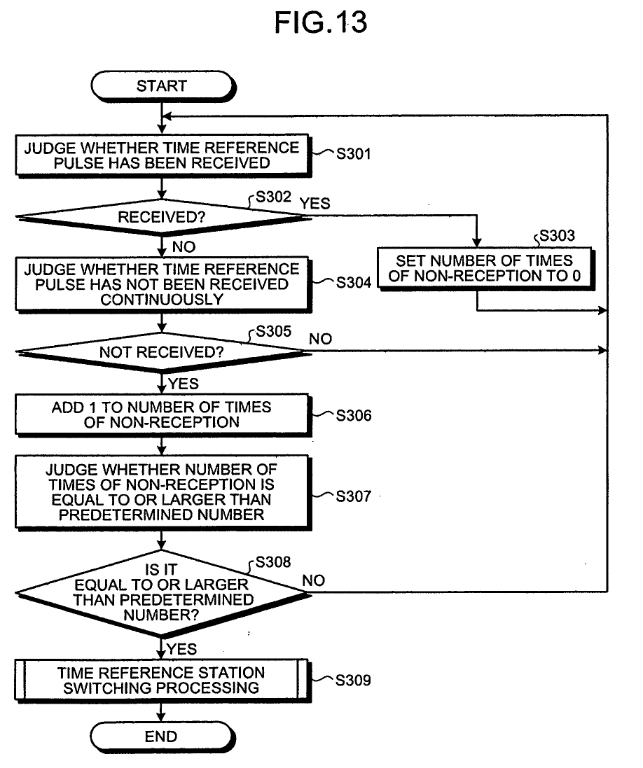

FIG. 13 is a flowchart of processing by the calculation server 200 for switching the time reference station. As shown in the figure, in the calculation server 200, the time-reference-pulse-reception monitor unit 222 judges whether a base station has received the time reference pulse (S301). When the base station has received the time reference pulse (“Yes” at step S302), the time-reference-pulse-reception monitor unit 222 sets the number of times of non-reception to 0 and shifts to step S301.

On the other hand, when the base station has not received the time reference pulse (“No” at step S302), the time-reference-pulse-reception monitor unit 222 judges whether the base station has not received the time reference pulse continuously for a predetermined time (step S304). When the base station has received the time reference pulse within the predetermined time (“No” at step S305), the time-reference-pulse-reception monitor unit 222 shifts to step S301.

When the base station has not received the time reference pulse continuously for the predetermined time (“Yes” at step S305), the time-reference-pulse-reception monitor unit 222 increments the number of times of non-reception (non-reception count) by one (step S306). The time-reference-pulse-reception monitor unit 222 judges whether the number of times of non-reception is equal to or larger than a predetermined number (step S307).

When the number of times of non-reception is smaller than the predetermined number (“No” at step S308), the time-reference-pulse-reception monitor unit 222 shifts to step S301. On the other hand, when the number of times of non-reception is equal to or larger than the predetermined number (“Yes” at step S308), the time-reference-pulse-reception monitor unit 222 generates the reset trigger and the time-reference-station control unit 223 executes time reference station switching processing (step S309).

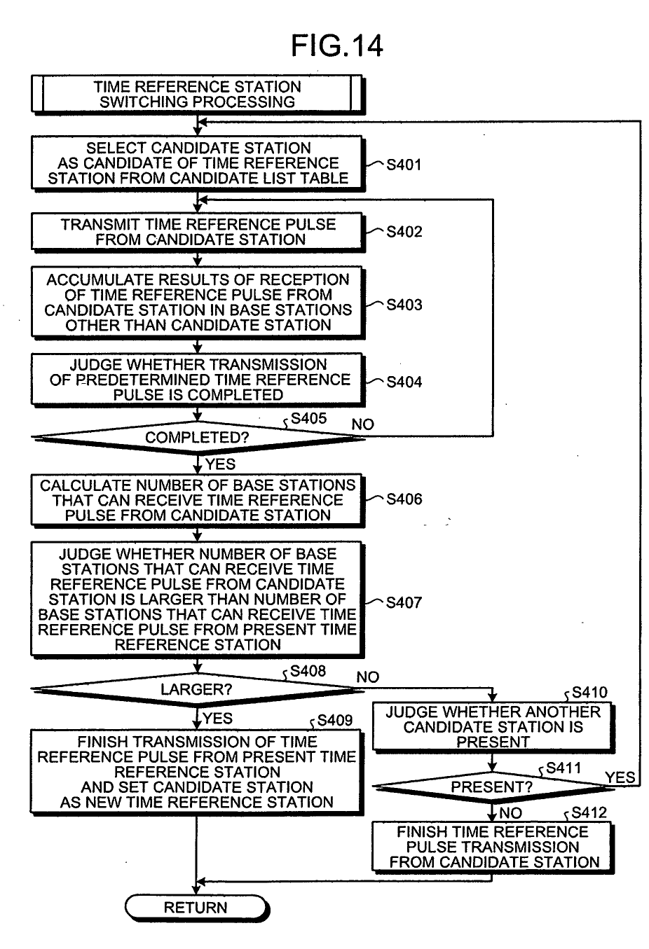

FIG. 14 is a flowchart of a processing procedure of the time reference station switching processing. As shown in the figure, the time-reference-station control unit 223 selects a candidate station as a candidate of the time reference station from the candidate list table 212 (step S401) and causes the candidate station to transmit the time reference pulse (step S402).

The time-reference-station control unit 223 accumulates results of reception of the time reference pulse from the candidate station in the base stations other than the candidate station (step S403). The time-reference-station control unit 223 judges whether the transmission of a predetermined time reference pulse has been completed (step S404). When the transmission of the predetermined time reference pulse has not been completed (“No” at step S405), the time-reference-station control unit 223 shifts to step S402.

On the other hand, when the transmission of the predetermined time reference pulse has been completed (“Yes' at step S405), the time-reference-station control unit 223 calculates the number of base stations that can receive the time reference pulse from the candidate station (step S406). The time-reference-station control unit 223 judges whether the number of base stations that can receive the time reference pulse from the candidate station is larger than the number of base stations that can receive the time reference pulse from the present time reference station (step S407).

When the number of base stations that can receive the time reference pulse from the candidate station is larger than the number of base stations that can receive the time reference pulse from the present time reference station (“Yes” at step S408), the time-reference-station control unit 223 finishes the transmission of the time reference pulse from the present time reference station, sets the candidate station as a new time reference station, and causes the candidate station to transmit the time reference pulse (step S409).

On the other hand, when the number of base stations that can receive the time reference pulse from the candidate station is smaller than the number of base stations that can receive the time reference pulse from the present time reference station (“No” at step S408), the time-reference-station control unit 223 judges whether another candidate station is present referring to the candidate list table 212 (step S410). When another candidate station is present (“Yes” at step S411), the time-reference-station control unit 223 shifts to step S401. When another candidate station is not present (“No” at step S411), the time-reference-station control unit 223 finishes the transmission of the time reference pulse from the candidate station (step S412).

In this way, the time-reference-pulse-reception monitor unit 222 compares the number of base stations that can receive the time reference pulse transmitted from the present time reference station and the number of base stations that can receive the time reference pulse transmitted from the candidate station and switches the time reference station. Therefore, it is possible to select an optimum base station that transmits the time reference pulse to the respective base stations as the time reference station.

As described above, in the radio positioning system according to this embodiment, during initial setting, even when a base station, a position coordinate of which is unknown, is present, the calculation server 200 performs two-way communication between a base station, a position coordinate of which is known, and the base station, a position coordinate of which is unknown, to calculate a distance between the respective base stations and calculates a position coordinate of the base station, a position coordinate of which is unknown (e.g., calculates a position coordinate using the triangulation). The transmission pulse transmitted from the mobile terminal 80 is received in the base station, a position coordinate of which is known, and the base station, a position coordinate of which is unknown. The calculation server 200 calculates a position coordinate of the mobile terminal 80 from a difference between the reception times. Therefore, it is possible to reduce a burden on the operator, efficiently carry out setting of the radio positioning system, and improve positioning accuracy.

The radio positioning system according to this embodiment monitors reception states of the time reference pulse in the respective base stations (a pulse for matching the timers of the base stations 100a to 100g) and switches, according to the reception state of the time reference pulse, a base station that transmits the time reference pulse (hereinafter, “time reference station”). Therefore, it is possible to effectively use the respective base stations and improve positioning accuracy.

The radio positioning system according to this embodiment has a function of transmitting and receiving the time reference pulse and the distance measurement pulse in all the base stations. Therefore, it is possible to calculate coordinates of the base stations and automate determination of the time reference state. It is possible to stably calculate a position coordinate of the mobile terminal 80 by dynamically changing the time reference station even when the environment changes.

In the respective kinds of processing explained in the embodiment, all or a part of the kinds of processing explained as being automatically performed can be performed manually. Alternatively, all or a part of the kinds of processing explained as being manually performed can be automatically performed by a publicly-known method. Besides, the processing procedures, the control procedures, the specific names, and the information including various data and parameters described in this document and shown in the drawings can be arbitrarily changed unless specifically noted otherwise.

The respective components of the mobile terminal 80, the base station 100a, and the calculation server 200 shown in FIGS. 3 to 5 are functionally conceptual and do not always have to be physically configured as shown in the figures. A specific form of distribution and integration of the devices is not limited to that shown in the figures. All or a part of the devices can be functionally or physically distributed or integrated in arbitrary units according to various loads, states of use, and the like. Moreover, all or an arbitrary part of the respective processing functions performed in the respective devices can be realized by a central processing unit (CPU) or a program analyzed and executed by the CPU or can be realized as hardware by a hardware logic.

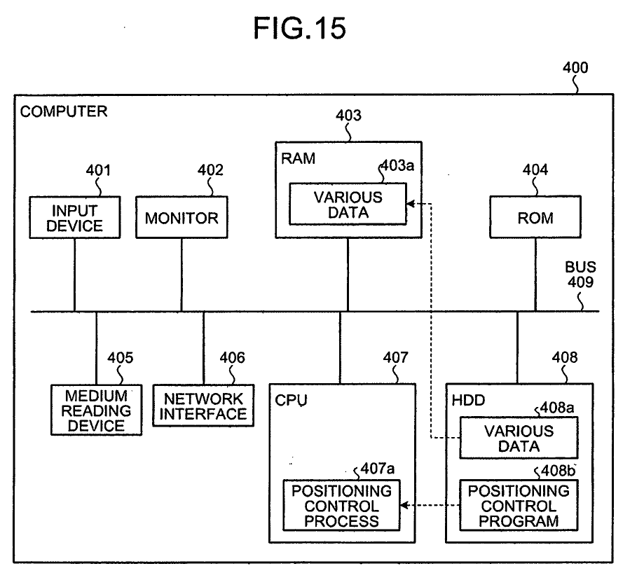

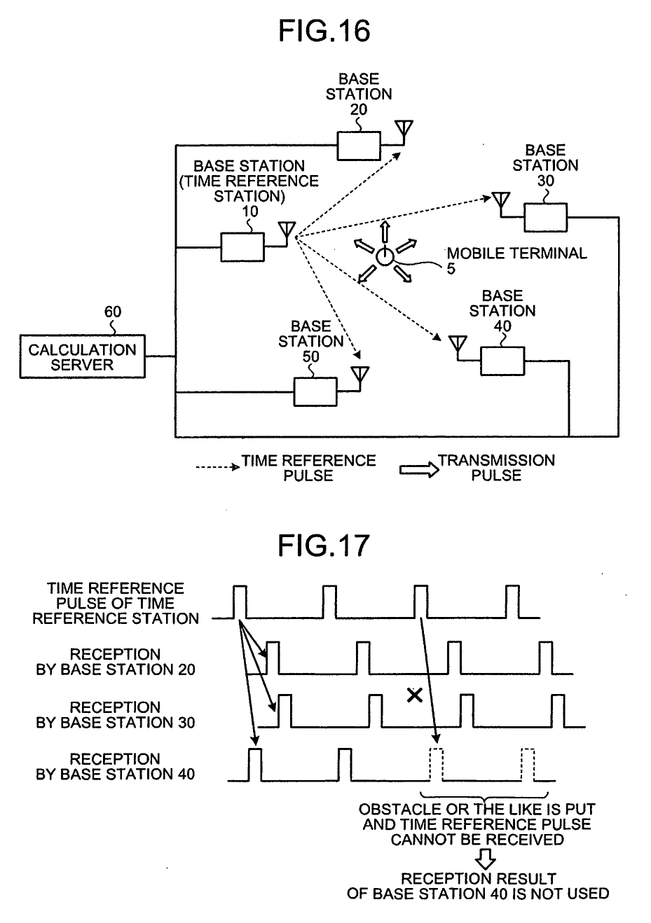

FIG. 15 is a diagram of a hardware configuration of the computer of the calculation server 200 shown in FIG. 5. As shown in FIG. 15, a computer 400 includes an input device 401 that receives data input from a user, a monitor 402, a random access memory (RAM) 403, a read only memory (ROM) 404, a medium reading device 405 that reads data from a storage medium, a network interface 406 that performs transmission and reception of data between the computer 400 and a base station, a central processing unit (CPU) 407, and a hard disk drive (HDD) 408, which are connected by a bus 409.

A positioning control program 408b that shows functions same as those of the calculation server 200 is stored in the HDD 408. When the CPU 407 reads out and executes the positioning control program 408b, a positioning control process 407a that realizes the functions of the control unit 220 of the calculation server 200 is started. The positioning control process 407a corresponds to the positioning calculating unit 221, the time-reference-pulse-reception monitor unit 222, the time-reference-station control unit 223, the time correcting unit 224, and the distance-measurement control unit 225 shown in FIG. 5.

In the HDD 408, various data 408a corresponding to the management table 211 and the candidate list table 212 shown in FIG. 5 are stored. The CPU 407 reads out the various data 408a stored in the HDD 408, stores the various data 408a in the RAM 403 as various data 403a, and carries out positioning control using the various data 403a stored in the RAM 403.

The positioning control program 408b shown in FIG. 15 does not always have to be stored in the HDD 408 from the beginning. For example, the positioning control program 408b can also be stored in “portable physical media” such as a flexible disk (FD), a compact disk-read only memory (CD-ROM), a digital versatile disk (DVD) disk, a magneto-optical disk, and an IC card inserted into the computer 400, “fixed physical media” such as a hard disk provided on the inside and the outside of the computer 400, and “other computers (or servers)” connected to the computer 400 through a public line, the Internet, a local area network (LAN), a wide area network (WAN), and the like. The computer 400 can read out the positioning control program 408b from these devices and execute the program.

According to the embodiment of the present invention, transmission and reception of a radio wave is performed between the first base station and the second base station to measure a distance between the base stations. A position coordinate of the first or second base station, a position coordinate of which is unknown, is calculated based on a result of the measurement. A base station that transmits a time reference pulse, which is used for calculating a time difference between reception times, is determined based on the result of the measurement of the distance between the base stations to cause the determined base station to transmit the time reference pulse. Therefore, it is possible to reduce a burden on an operator who sets the radio positioning system and accurately determine a position coordinate of the mobile terminal even when the environment changes.

According to the embodiment of the present invention, maximum values of distances between the respective base stations and the other base stations are calculated based on the result of the measurement of the distance between the base stations. A base station having a maximum value smallest among the calculated maximum values is determined as a base station that transmits the time reference pulse. Therefore, it is possible to stably receive the time reference pulse in the base stations and improve positioning accuracy for the mobile terminal.

According to the embodiment of the present invention, base stations are selected out of the base stations, the numbers of other base stations, distances to which from the selected base stations can be measured, are counted and, based on a result of the counting, a base station having a maximum number of other stations, distances to which from the base station can be measured, is determined as a base station that transmits the time reference pulse. Therefore, it is possible to transmit the time reference pulse to a larger number of base stations and improve positioning accuracy for the mobile terminal.

According to the embodiment of the present invention, maximum values of fluctuations in distances between the respective base stations and the other base stations are calculated based on the result of the measurement of the distance between the base stations and a base station having a maximum value smallest among the calculated maximum values of fluctuations is determined as a base station that transmits the time reference pulse. Therefore, it is possible to stably receive the time reference pulse in the base stations and improve positioning accuracy for the mobile terminal.

According to the embodiment of the present invention, a reception state in the base station that receives the time reference pulse is monitored. When it is judged based on a result of the monitoring that the base station does not receive the time reference pulse for a predetermined time or more, the base station that transmits the time reference pulse is switched. Therefore, it is possible to improve positioning accuracy for the mobile terminal.

According to the embodiment of the present invention, priority order of the base station that transmits the time reference pulse is determined based on the result of the measurement and the result of the monitoring. The base station that transmits the time reference pulse is switches based on the determined priority order. Therefore, it is possible to efficiently determine the base station that transmits the time reference pulse.

According to the embodiment of the present invention, the time reference pulse is transmitted from different base stations at first timing and second timing, respectively. The base station that transmits the time reference pulse is determined based on reception states in the respective base stations of the time reference pulse transmitted at the first timing and reception states in the respective base stations of the time reference pulse transmitted at the second timing. Therefore, it is possible to efficiently switch the base station that transmits the time reference pulse.

According to the embodiment of the present invention, distances among the respective base stations are measured at every predetermined time. Therefore, it is possible to improve positioning accuracy.

According to the embodiment of the present invention, distances among the respective base stations are measured at timing different from timing when the time reference pulse is transmitted. Therefore, it is possible to improve positioning accuracy.

According to the embodiment of the present invention, an ultra wide band (UWB) pulse is used for radio communication among the base stations and radio communication between the respective base stations and the mobile terminal. Therefore, it is possible to improve positioning accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A radio positioning system, comprising:
a plurality of base stations, each receiving a radio wave from a mobile terminal, and including a first base station whose position coordinates are known and a second base station whose position coordinates are unknown;
a distance measuring unit that measures a distance between the first and the second base stations based on a result of exchanging radio waves between the first and the second base stations;
a position-coordinate calculating unit that calculates position coordinates of the second base station based on the measured distance;
a determination control unit that determines a time reference station out of the base stations, and controls the time reference station to transmit a time reference pulse; and
a control unit that calculates a time difference between reception times at which the base stations receive the wave signal from the mobile terminal, and calculates position coordinates of the mobile terminal based on the time difference.

2. The radio positioning system according to claim 1, wherein the determination control unit calculates maximum values of distances between the respective base stations and the other base stations based on the result of the measurement to determine a base station having a smallest maximum value among the calculated maximum values as the time reference station.

3. The radio positioning system according to claim 1, further comprising a counting unit that selects a base station out of the plurality of base stations and counts a number of other base stations, distances to which from the selected base station can be measured, wherein
the determination control unit determines the time reference station based on a result of the counting of the counting unit, a base station having a largest number of other base stations, distances to which from the selected base station can be measured.

4. The radio positioning system according to claim 1, wherein the determination control unit measures distances from the other base stations a plurality of times in the distance measuring unit for each of the base stations, calculates fluctuations in the measured distances, calculates maximum values of the fluctuations, and determines a base station having a smallest maximum value among the calculated maximum values as the time reference station.

5. The radio positioning system according to claim 1, further comprising a reception-state monitoring unit that monitors a reception state in a base station that receives the time reference pulse, wherein
the determination control unit switches the time reference station, when determining based on a result of the monitoring of the reception-state monitoring unit that the base station does not receive the time reference pulse for a predetermined time or more.

6. The radio positioning system according to claim 5, wherein the determination control unit determines, based on the result of the measurement and the result of the monitoring, priority order of the base station that transmits time reference pulse, and switches, based on the determined priority order, the base station that transmits the time reference pulse.

7. The radio positioning system according to claim 6, wherein the determination control unit controls the base stations to transmit the time reference pulse from different base stations at first timing and second timing and determines the time reference station, based on reception states in the respective base stations of the time reference pulse transmitted at the first timing and reception states in the respective base stations of the time reference pulse transmitted at the second timing.

8. The radio positioning system according to claim 1, wherein the distance measuring unit measures distances among the respective base stations at every predetermined time.

9. The radio positioning system according to claim 8, wherein the distance measuring unit measures distances among the respective base stations at timing different from timing when the time reference pulse is transmitted.

10. The radio positioning system according to claim 1, wherein an ultra wide band (UWB) pulse is used for radio communication among the base stations and radio communication between the respective base stations and the mobile terminal.

11. A radio positioning server apparatus used in a system including a plurality of base stations each receiving a radio wave from a mobile terminal, the base stations including a first base station whose position coordinates are known and a second base station whose position coordinates are unknown, the apparatus comprising:
a distance measuring unit that measures a distance between the first and the second base stations based on a result of exchanging radio waves between the first and the second base stations;
a position-coordinate calculating unit that calculates position coordinates of the second base station based on the measured distance;
a determination control unit that determines a time reference station out of the base stations, and controls the time reference station to transmit a time reference pulse; and
a control unit that calculates a time difference between reception times at which the base stations receive the wave signal from the mobile terminal, and calculates position coordinates of the mobile terminal based on the time difference.

12. A method of radio positioning a mobile terminal in a system including a plurality of base stations, the base stations including a first base station whose position coordinates are known and a second base station whose position coordinates are unknown, the method comprising:
exchanging radio waves between the first and the second base stations;
measuring a distance between the first and the second base stations based on a result of exchanging radio waves between the first and the second base stations;
calculating position coordinates of the second base station based on the measured distance;
determining a time reference station out of the base stations;
controlling the time reference station to transmit a time reference pulse;
calculating a time difference between reception times at which the base stations receive the wave signal from the mobile terminal; and
calculating position coordinates of the mobile terminal based on the time difference.

13. The method according to claim 12, wherein the determining includes calculating maximum values of distances between the respective base stations and the other base stations based on the result of the measurement to determine a base station having a smallest maximum value among the calculated maximum values as the time reference station.

14. The method according to claim 12, further comprising:
selecting a base station out of the plurality of base stations; and
counting a number of other base stations, distances to which from the selected base station can be measured, wherein
the determining includes determining the time reference station based on a result of the counting of the counting unit, a base station having a largest number of other base stations, distances to which from the selected base station can be measured.

15. The method according to claim 12, wherein the determining includes
measuring distances from the other base stations a plurality of times in the distance measuring unit for each of the base stations,
calculating fluctuations in the measured distances, calculating maximum values of the fluctuations, and
determining a base station having a smallest maximum value among the calculated maximum values as the time reference station.

16. The method according to claim 12, further comprising monitoring a reception state in a base station that receives the time reference pulse, wherein
the determining includes switching the time reference station, when determining based on a result of the monitoring of the reception-state monitoring unit that the base station does not receive the time reference pulse for a predetermined time or more.

17. The method according to claim 16, wherein the determining includes determining, based on the result of the measurement and the result of the monitoring, priority order of the base station that transmits time reference pulse, and switching, based on the determined priority order, the base station that transmits the time reference pulse.

18. The method according to claim 17, further comprising controlling the base stations to transmit the time reference pulse from different base stations at first timing and second timing, wherein
the determining includes determining the time reference station, based on reception states in the respective base stations of the time reference pulse transmitted at the first timing and reception states in the respective base stations of the time reference pulse transmitted at the second timing.

19. The method according to claim 12, wherein the measuring includes measuring distances among the respective base stations at every predetermined time.

20. The method according to claim 19 wherein the measuring includes measuring distances among the respective base stations at timing different from timing when the time reference pulse is transmitted.

21. The method according to claim 12, wherein an ultra wide band (UWB) pulse is used for radio communication among the base stations and radio communication between the respective base stations and the mobile terminal.
